(19) United States
(12) Patent Application Publication
(10) Pub. No.: US 2004/0172385 A1
(43) Pub. Date: Sep. 2, 2004

(54) Database query and content transmission governor

(76) Inventor: Vikram Dayal, Ashburn, VA (US)

Correspondence Address: JINAN GLASGOW, P O BOX 28539, RALEIGH, NC, 276118539

(21) Appl. No.: 10/375,248

(22) Filed: Feb. 27, 2003

(51) Int. Cl. G06F 17/30; G06F 7/00

(52) U.S. Cl. 707/3

(57) ABSTRACT

A database query management system including a report governor and an intermediate result status storage in communication with at least one client and a server; the server further including a database, a query engine, and a formatting engine; wherein the report governor can pause a query request if system resource usage has exceeded a predetermined threshold; can pause formatting of query results if system resource usage has exceeded a predetermined threshold; and can pause report transmission to the client if data transmission to client is exceeding a predetermined threshold; thereby preventing client and server timeouts and eliminate lost work time due to these timeouts.

### BACKGROUND OF THE INVENTION

(1) Field of the Invention

The present invention relates generally to data processing control systems and, more particularly, to a database query management system for in-process monitoring and control of database queries and report transmission.

(2) Description of the Prior Art

Database querying can have associated improper service or service outage problems. When querying databases, users can issue overly broad or mistakenly constructed queries that result in the selection of a large number of records that exceeds the capacity of the system or is useless to the user. For example, a user might mistakenly issue a query that results in the creation of a multiplication of rows of result data instead of an intersection of result data. A user may also issue a query with selection criteria that is very wide, also resulting in the selection of a large number of records. Sometimes incorrectly formed queries result in a multiplication of two or more tables causing a result set of a large number of results. In Prior Art, there is no clean way of pausing this kind of a query. Such reports are called Run-Away Reports. In other cases, the multiplication of tables might be desirable in which case one would want to continue the paused execution of the query.

Alternatively or additionally, when a large number of queries are submitted to the system, the server may become too busy to simultaneously perform all submitted queries. In these cases, the server may abort the processing of some queries and may notify the user that the server is busy. In extreme cases the server can crash when overloaded with queries.

Prior art solutions to an over-taxed database query engine were the use of query timeouts, client timeouts, and/or partial display of completed query results. However, these conditions do not allow the reporting engine to display a partially completed query result and continue the query and report from the end of the partially completed query and report. In such cases, reports are unable to generate correct level and grand totals. Other report generators would generate reports based on number of lines and lines per page, displaying one page at a time and having the user continue the query and report by issuing a command, typically by selecting the “Next” button, in an attempt to reduce server load.

Prior art report writers currently run through the generation of an entire report in a single step. In some cases, e.g. Actuate, the report writer creates intermediate data files that stored the results based on record types. When a user requests a part or page of the report, the page is built up for display by reformatting the intermediate data file and displaying and/or printing the result. Such implementations require enormous amounts of disk storage for each report.

In these prior art embodiments, once a query was issued, the reporting engine would run through the entire result set. In some cases it would reformat and display the results immediately, e.g. Crystal Reports, Brio, and Cognos, or it would store the result in intermediate tables of file to be formatted for display and or printing at a later time.

Thus, prior art database query engines and report generators did not have the functionality to allow the user to pause the execution of a query, study the partial result, and then either terminate the query or allow it to proceed, as desired. These query engines also lacked the capacity to monitor server usage, suspend a query(s) when server usage reached a predetermined level, and resume the query(s) from the stopping point when server usage had dropped below a predetermined level. These query engines also did not monitor content transmission to the client and did not allow the server to stop content transmission to the client when a predetermined level of transmission was reached, thereby preventing client errors.

Therefore, a need exists for a database query and content transmission governor that can monitor system resources to allow the system to automatically stop querying and/or stop transfer of content when the server is overtaxed or when too much content has been transferred to the client, thus preventing server and/or client errors; and allow the query and report to resume from the stopping point at a later time, thus reducing lost work time and server time.

Additionally, the need exists for a database query engine that can allow the user to suspend a query, monitor the results of a partially-completed query, and then continue the query from the stopping point or terminate the query, as desired.

Definitions

Cursor—short for current set of records, the currently selected set of records. A database cursor is a reference to a single key/data pair in the database. It supports traversal of the database and update and delete of individual rows of the database. Typically a database query returns a cursor. The cursor can be perceived as a pointer to the virtual table of results of a select statement with the pointer pointing to the current row.

Query Status—When a query is executed the database engine performs a series of tasks that include—query parsing, query optimization, execution path planning, data retrieval and formatting etc. The query can be abandoned at any stage for a variety of reasons. Query Status refers to all the steps outlined and the state the query is in. For example, a query with a complex join of very large sized tables could result in the query remaining in the data fetch state for a very long time. In this condition, each cursor->next command would take a long time to execute. In another case the query could be going through a simple table lookup where each data fetch would take very few resources, but the query would still take a long time to execute. In both of these cases, the query status can be thought of as “Executing”. Other query status could be “Paused”, “Aborted”, “Executed”, and the like.

Process—An executing program or task.

Thread—a part of a program, task, or process that can execute independently of other parts. Operating systems that support multithreading enable programmers to design programs whose threaded parts can execute concurrently.

Timeout—premature termination of a job resulting in loss of executed work. Timeouts can be due to server overload, termed a server timeout or server failure; or due to client overload, termed a client timeout.

Total CPU time—Total Time the CPU has spent on the process/thread

Total Elapsed Time: Time difference between the current time and the time the query was submitted.

IO Time: Time taken by the system to perform any IO's.

Message Transmission Time or Message Transit Time: Time taken to transmit a message

Report Formatting Time: Time taken to format the data—can be either elapsed time or CPU time

Query Time: Time taken by the database to run the query.

Memory Utilization: amount of memory taken up by a process or thread.

Disk Space Utilization: Amount of space taken on the disk.

Query Row Fetch Time: Time elapsed to fetch each row of query results in a Cursor. This is the finest granularity, or resolution, with which the overall performance of the Report Governor can be controlled.

### SUMMARY OF THE INVENTION

The present invention is directed to a database query management system and method that: can pause a query if system resource usage has exceeded a predetermined threshold and resume the query when system resource usage falls below a predetermined threshold; can pause formatting of query results if system resource usage has exceeded a predetermined threshold and resume formatting when system resource usage falls below a predetermined threshold; and can pause report transmission to a client if data transmission to the client is exceeding a predetermined threshold and resume transmission when data transmission falls below a predetermined threshold; thereby preventing client and server timeouts and reduce server resources due to these timeouts.

The present invention is further directed to providing a system and method for a client to inquire into the status of an ongoing query and resuming the query from the paused record or terminating the query, as desired.

Accordingly, one aspect of the present invention is to provide a database query management system including a report governor and an intermediate result status storage in communication with at least one client and a server; wherein the server and the at least one client are in data communication; the server further including a database, a query engine, and a formatting engine; and wherein the report governor can pause a query if system resource usage has exceeded a predetermined threshold and resume the query when system resource usage falls below a predetermined threshold; can pause formatting of query results if system resource usage has exceeded a predetermined threshold and resume formatting when system resource usage falls below a predetermined threshold; and can pause report transmission to a client if data transmission to the client is exceeding a predetermined threshold and resume transmission when data transmission falls below a predetermined threshold.

Another aspect of the present invention is to provide a method for managing database queries including the steps of: receiving a query request from a client; monitoring system resources to determine if sufficient resources are available to execute the query; if sufficient resources are available, forwarding the query to query engine; monitoring the system resource usage; pausing the query if system resources use is above a predetermined level; storing query status; forwarding partial results to formatting engine; sending partial report to client; and resuming the query when system resources use falls below predetermined level.

Still another aspect of the present invention is to provide a method for inquiring into the status of an ongoing query including the steps of: receiving a query inquiry from a client; pausing the query; storing the query status in an intermediate result status storage; forwarding the partial results to formatting engine; sending the partial report to client; and continuing the query when the client sends a query continuation request.

These and other aspects of the present invention will become apparent to those skilled in the art after a reading of the following description of the preferred embodiment when considered with the drawings.

### BRIEF DESCRIPTION OF THE DRAWINGS

FIG. 1 is a flow diagram of a database query management system constructed according to the present invention.

FIG. 2 is another flow diagram of a database query management system constructed according to the present invention.

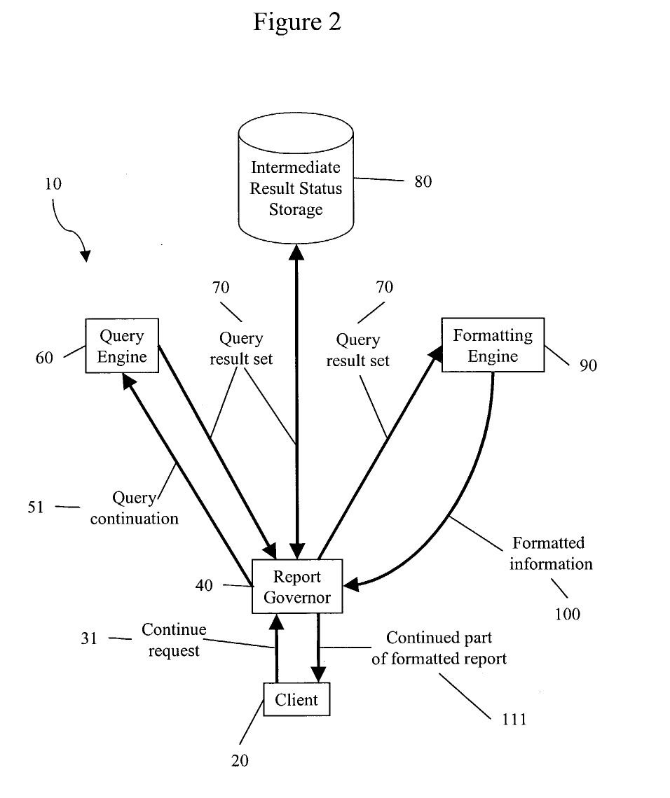

FIG. 3 is another flow diagram of a database query management system constructed according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

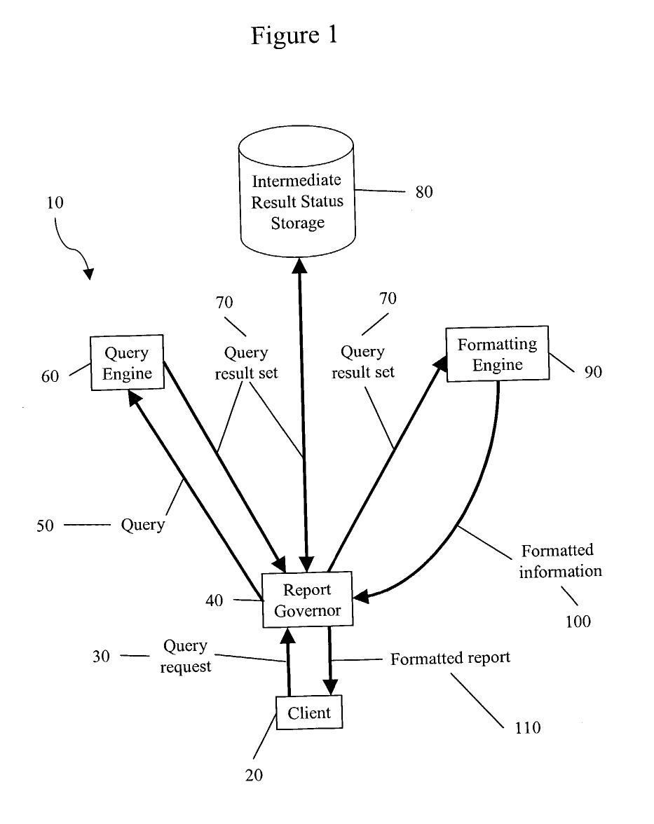

Referring now to the drawings in general, the illustrations are for the purpose of describing a preferred embodiment of the invention and are not intended to limit the invention thereto. As best seen in FIG. 1, one embodiment of a database management system (DBMS) generally referenced as 10, incorporating the present invention, includes a client 20, report governor 40, query engine 60, intermediate results status storage 80, and report formatting engine 90. The report governor assigns certain amounts of system resources to the query engine, formatting engine and the transmission mechanism. These resource assignments can either be default values assigned by the report governor, or can be values assigned at the time of the request. Some representative resources that can be assigned include Total CPU time, Total Elapsed Time, IO Time, Message Transmission Time, Report Formatting Time, Query Time, Memory Utilization, Disk Space Utilization When the client 20 issues a query request 30, the report governor 40 assesses the status of the system, including CPU Utilization, Memory Utilization, Disk Utilization, Network Congestion, and the like. If the system resources are sufficient, the query governor forwards the query 50 to the query engine 60. The query engine submits the database query to the database engine. The database engine can be any Commercial Off the Shelf (COTS) database like Oracle, Ingres, Sybase, DB2, MySQL or it can be simple file system (indexed or flat files), or it can be an XML Structure or DOM. Most database engines return the results of the query in a form of a table, individual records of which can be manipulated by using a Cursor. The query engine simply needs a means of getting records from the database engine either via Cursor or other API lookup mechanism. The time between every fetch of the result Record is called Query Fetch Time and is the smallest granularity, or resolution, with which the report governor can effectively function. After getting each record from the database engine, the query engine passes the information to the report governor, which forwards data to the formatting engine.

In another embodiment of the same invention, the query engine can pass the data to the formatting engine directly and pass on only relevant or a copy of the information to the report governor. During the execution of the query by the query engine, the report governor continues to monitor system resources, including keeping track of all the resources used up by the query engine and the formatting engine because of the information flow between all the components and the report governor.

If the system resources are exceed, the report governor can pause execution of the query and send the partial results to the formatting engine 90 and the status of the query at pause, including the Row Number and ResultSet, to the intermediate result status storage 80. The partial results that were sent to the formatting engine 90 are formatted and the formatted information 100 is sent to the report governor. The report governor monitors the client status, determining if the client is capable of receiving the report. If so, the report governor sends the formatted report 110 to the client. After the report governor has determined that the system resources are capable of resuming the query, the report governor signals the query engine to resume execution of the query 51. The query engine retrieves the intermediate result status and resumes execution of the query at the pause point.

In cases where the client may wish to monitor the execution of the query, the client pauses the query execution, monitors the partial report, then either terminates the query or issues a continue request 31. The continue request is processed by the governor 40 which sends the query continuation command 51 to the query engine if system resources are adequate. The query results are then sent to the formatting engine, which forwards the formatted information to the report governor. The report governor then sends the continued part of the formatted report 111 to the at least one client. Preferably, a single instance of the system can render the same query results to more than client.

Additionally, the report governor monitors content transfer from the server. Specifically, the report governor monitors amount of data transferred in bytes, number of lines rendered, and/or time taken in the transfer. The report governor stops transfers if the system transfers are degrading or excess content is transferred. These functions prevent server time-outs. For example, the report governor may be programmed to stop a query if the elapsed time in data transfer exceeds a predetermined time, for example, 30 seconds. Thus, the present invention prevents client timeouts and allows client control of on-going queries.

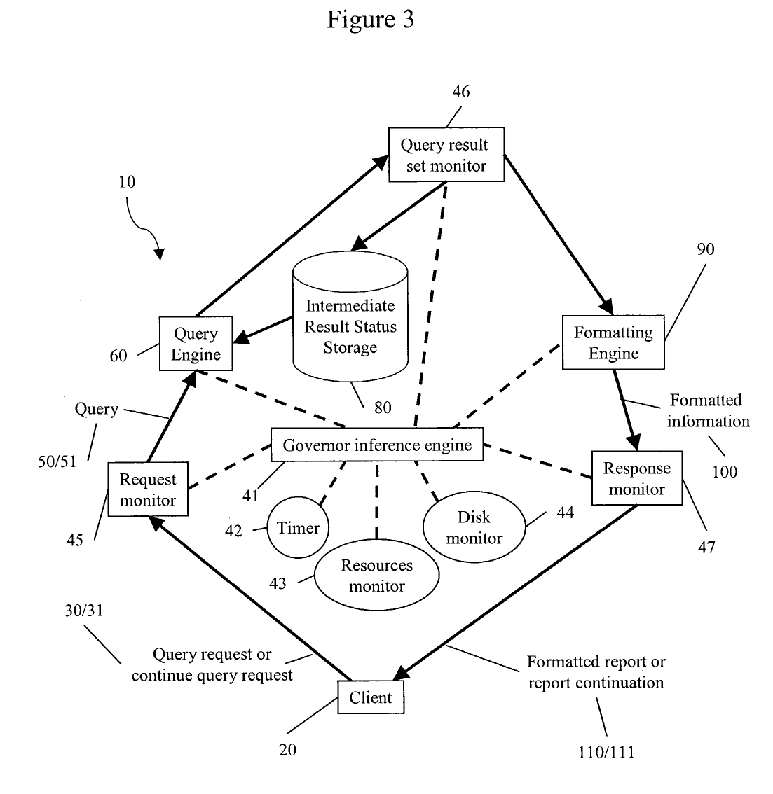

In another embodiment of the present invention, shown in FIG. 3, the report governor is a governor inference engine 41 in communication with a timer 42, resources monitor 43, disk monitor 44, request monitor 45, query result set monitor 46, and response monitor 47. The resources monitor 43 is in communication with the Operating System (OS) and monitors the overall performance of the machine, such as Memory Utilization, Virtual memory utilization, Virtual Memory swapping rate (system thrashing), and the like. The disk monitor 44 is in communication with the disk subsystem of the computer/OS and monitors the amount of Disk storage consumed vs. allowed. In this embodiment, a query request is initiated by the client 20. The request monitor 45 signals the governor inference engine 41 that a query request has been initiated. The governor inference engine monitors the system status via the timer, resources monitor, and disk monitor to determine if a query can be submitted to the query engine 60. If sufficient system resources are available, the query is submitted to the query engine 60 for execution. The governor inference engine continues to monitor the system resources and stops one or more queries if the system resource utilization exceeds a predetermined limit. Partial or completed query results are sent to a query result set monitor, which keeps track of the number of records processed and amount of time taken to process these records. In other embodiments, the system can connect to databases that connect support metrics API's for additional information. The governor determines if the formatting engine has adequate resources. If so, the query results are sent to the formatting engine. If the query results are incomplete, the partial results are sent to the formatting engine 90 and the query status is sent to the intermediate result status storage 80.

When the governor inference engine determines that the query engine has sufficient free capacity to continue executing a paused query, the report governor signals the query engine to resume the query. The status of the query is communicated to the query engine from the intermediate result status storage 80 and the query engine recommences the query from the pause point.

Although the present invention has been described using a report generator system, other data-intensive applications can use the present invention to optimize operation. For example, the invention can be used in OLAP, Data-mining and Business intelligence operations where data retrieval can be from any source (database, XML, Flat File).

To enable simultaneous execution of the various tasks in the present invention, a program according to the present invention is preferably composed of multiple threads, such that operating systems that support multithreading can execute the threaded parts concurrently, thus improving the performance of the present invention. More preferably, the program uses object-oriented programming to permit the synchronization mechanisms necessary for asynchronous multithreading. Thus, each component can be an independently running process or an independently running thread. Alternatively, each component can be performed sequentially. That is, each component is a simple module or class or procedure call in one simple program that executes each component one at a time.

The report governor according to the present invention monitors data flow between the query engine and the formatting engine and the output of the reporting engine. Between the query engine and the formatting engine, the report governor monitors system resources and pauses report generation when system resource use reaches a pre-determined threshold. For example, if the Server is bound by heavy CPU or memory bound tasks that are delaying the processing of the formatting engine or the formatting engine itself is involved in very heavy computational task, the report governor can signal all the relevant components to pause the execution of the report The report governor also signals the report query engine to save its state. The report query engine can either save the result set and associated database cursors for later use or clear all database cursors associated with the query. The report governor also signals the formatting engine that, though the formatting engine will receive no more data, there is still more data to be formatted. Having this status information, the formatting engine can then provide a “next” button with the partial report. The report governor also stores the intermediate results from the formatting engine for the continue request. Alternatively, the intermediate results can be passed on to the client, which can do its own computation or pass the results back to the governor thus making the governor into a stateless machine.

When the client requests a continuation of the report, the report governor can either restart at the beginning of the database or restart from the cursor. If restarting from the beginning, the query engine discards records until it reaches the record stored in the intermediate results and then begins passing query results to the formatting engine. Alternatively, if continuing from the pause record stored in the intermediate result status, the query engine simply resumes sending the query continuation records to the formatting engine, which formats them and forwards to report continuation to the client.

On the output side of the reporting engine, the report governor monitors the delivery mechanism to ensure that network traffic is not excessive and reducing dataflow to the client, causing client errors. For example, The clients that are connected via low speed lines might have large amounts of data that might which might take up too much download time. In this case, when the report governor senses that too much time has elapsed, it can pause the further generation of data. In another example, if there is network congestion due to some other reason, the report governor can pause the execution of the query. In the case where the site is very busy and a very large number of database hits is on going, individual queries usually end up getting slower and slower, causing some queries to time out. With the invention installed and operating, the governor would be monitoring the time taken by each query and when time taken by the query exceeds a threshold, the query is paused, thus relieving the database and other system resources for other executing queries.

In cases where a reporting engine is used as a part of a quick search on a portal site, it is important not to overwhelm the user with large amounts of data; hence the restriction would be to pause the report after every n records, where n is a small, pre-selected number. In this case the report governor would monitor the number of records read and pause the report when n records were reported. The code for the report governor can be located on a server, in a content provider, or as a stand-alone program. If on a server, the server may be a web server, such as the Internet Information Server (IIS) based on Active Server Pages (ASP); a database server, such as Oracle; or a J2EE application server, such as BEA Weblogic, Allaire JRUN, IBM WebSphere, or Apache Tomcat. In another embodiment, the report governor code may be in a server-based application with embedded reporting, such as one having CGI or Server side scripting. Alternatively, the report governor code can be incorporated in the content provider. For example, it can be incorporated within any existing or new application like Payroll Systems or Patient Information Systems in the healthcare industry. In another alternative embodiment, the present invention is a standalone program not residing on the server. For example, the present invention can be installed on a client or other computer that is in communication with the DBMS on another server.

In one example of the present invention installed on web server, the database query management system according to the present invention is a report governor incorporated into a report generator, such as the Avman Right Reporter, which resides entirely on the server. The Avman Right Reporter system is HTML-based and uses a web browser such as Netscape or Internet Explorer to specify a query and report from a client machine. No additional client software is necessary. Thus, the Avman Right Reporter is entirely server-based and there is no need to install other client applications or plug-ins on the desktops. The incorporation of the report governor and the use of web browsers as client software makes this system much less error-prone than systems that require client software installation and do not manage server load like the present invention. Additionally, such a system allows for easier software upgrades because only the server has system-specific software.

Thus, the present invention is a database query management system, including a report governor and an intermediate result status storage running on a computer and in communication with at least one client and a server; wherein the server and the at least one client are in communication; the server further including a database, a query engine, and a formatting engine; and wherein the report governor: i) can pause a query request if system resource usage has exceeded a predetermined threshold and resume the query when system resource usage falls below a predetermined threshold; ii) can pause formatting of query results if system resource usage has exceeded a predetermined threshold and resume formatting when system resource usage falls below a predetermined threshold; and iii) can pause report transmission to the client if data transmission to client is exceeding a predetermined threshold and resume transmission when data transmission falls below a predetermined threshold; thereby preventing client and server timeouts and eliminate lost work time due to these timeouts.

The system can also allow a client to pause a query to initiate an executing query inquiry and the query status is saved in the intermediate result status storage such that the query can be continued at the pause record/cursor.

The report governor can further include a governor inference engine, a request monitor, a query result set monitor, a response monitor, a resources monitor, a timer, and a disk monitor.

A method of managing database queries and report transmissions according to the present invention includes the following steps:

1) receiving a query request from a client;

2) monitoring system resources to determine if sufficient resources are available to execute the query;

3) if sufficient resources are available, forwarding the query to the query engine for execution;

4) monitoring the query engine;

5) stopping the query if system resources use is above a predetermined level;

6) storing the query status;

7) forwarding the partial results to the formatting engine;

8) sending a partial report to the client;

9) resuming the query when system resources use falls below a predetermined level;

A client inquiry of an ongoing query further includes the following steps:

10) receiving a query inquiry from a client;

11) pausing the query;

12) storing the query status;

13) forwarding the partial results to the formatting engine;

14) sending the partial report to the client; and

15) continuing the query if the client sends a query continuation request

16) or terminate the query if the client sends a query termination request.

In these methods, each step can be an independently running process or an independently running thread. Alternatively, each step can be performed sequentially. That is, each step is a simple module or class or procedure call in one simple program that executes each procedure one at a time.

Certain modifications and improvements will occur to those skilled in the art upon a reading of the foregoing description. All modifications and improvements have been deleted herein for the sake of conciseness and readability but are properly within the scope of the following claims.

I claim:

1. A database query management system comprising:
i) a report governor and
ii) an intermediate result status storage,
running on a computer and in communication with at least one client and a server;
wherein the server and the at least one client are in communication;
the server further including a database, a query engine, and a formatting engine; and
wherein the report governor:
i) can pause a query request if system resource usage has exceeded a predetermined threshold and resume the query when system resource usage falls below a predetermined threshold
ii) can pause formatting of query results if system resource usage has exceeded a predetermined threshold and resume formatting when system resource usage falls below a predetermined threshold;
iii) can pause report transmission to the client if data transmission to client is exceeding a predetermined threshold and resume transmission when data transmission falls below a predetermined threshold;
thereby preventing client and server timeouts and eliminate lost work time due to these timeouts.

2. The system as in claim 1, wherein a client can pause a query to initiate an executing query inquiry and the query status is saved in the intermediate result status storage such that the query can be continued at the pause record/cursor.

3. The system as in claim 2 wherein the report governor further includes the
a governor inference engine;
a request monitor,
a query result set monitor,
a response monitor,
a resources monitor,
a timer,
and a disk monitor.

4. The system as in claim 3, wherein the governor inference engine comprises a multiple thread program.

5. The method of claim 3, wherein each component is an independently running process.

6. The method of claim 3, wherein each component is an independently running thread.

7. The method of claim 3, wherein each component executes sequentially.

8. The system as in claim 2, wherein the server and the client are the same machine.

9. A method for managing database queries comprising the steps of:
receiving a query request from a client;
monitoring system resources to determine if sufficient resources are available to execute the query, format the information, and transmit the report;
if sufficient resources are available, forwarding the query to query engine;
monitoring the system resource usage;
pausing query if system resources use is above a predetermined level;
storing query status;
forwarding partial results to formatting engine;
sending partial report to client; and
continuing query when system resources use falls below a predetermined level.

10. The method as in claim 9 further including
receiving a query inquiry from a client;
pausing the query;
storing the query status in an intermediate result status storage;
forwarding the partial results to formatting engine;
sending the partial report to client;
continuing the query if the client sends a query continuation request;
terminating the query if the client sends a query termination request.

11. The method of claim 9, wherein each step is an independently running process.

12. The method of claim 9, wherein each step is an independently running thread.

13. The method of claim 9, wherein each step is sequential.
